(19) United States
(12) Patent Application Publication
(10) Pub. No.: US 2007/0024415 A1
(43) Pub. Date: Feb. 1, 2007

(54) Shielded pressure-actuated circuit

(76) Inventors: Bryan Maynes, Sandy, UT (US); John Haberle, West Jordan, UT (US); Daniel Marriott, Salt Lake City, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/494,288

(22) Filed: Jul. 27, 2006

Related U.S. Application Data
(60) Provisional application No. 60/702,866, filed on Jul. 27, 2005.

(51) Int. Cl. H01C 10/10

(52) U.S. Cl. 338/99

(57) ABSTRACT

A shielded pressure-actuated circuit in which two parts of a circuit may be selectively brought into contact. In one embodiment, the circuit is formed as a touch-controlled potentiometer. A shielding layer permits operation in environments of greater than 50 degrees Celsius above ambient temperatures. The shielding layer also extends the useful life of the device by increasing its durability. In one embodiment, the shielding layer comprises borosilicate or fiberglass affixed to the apparatus at the place where a force is applied to actuate the device.

### RELATED APPLICATION

This Application claims priority to U.S. provisional patent application Ser. No. 60/702,866 filed on Jul. 27, 2005.

### BACKGROUND

The present invention relates to pressure-actuated electronic components. More particularly, the invention may relate to pressure-actuated electronic components configured as potentiometers, which in some embodiments are actuated by touch control.

Potentiometers for controlling voltage selection are used in numerous types of applications in both home and industry. For example, these devices may be used in the control panels of such things as aircraft and aerospace applications, large construction equipment, computers, lighting systems, arcade games, or kitchen appliances, to name just a few.

The functionality and dependability of pressure-actuated devices, including pressure-actuated potentiometers, are subject to degradation in high-temperature environments. The functionality and dependability of such a device may also degrade over time as components of the device become worn under the pressure used to actuate the device.

### SUMMARY

In one embodiment of the present invention, a pressure-actuated circuit apparatus is configured as a linear potentiometer. A shielding material is affixed to the area to which pressure may be applied to actuate the device. This shielding material may provide for increased durability and for operation in high-temperature environments.

### BRIEF DESCRIPTION OF THE FIGURES

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 is a cross-sectional view of a prior art device.

FIG. 2 is a cross-sectional view of a prior art device as in FIG. 1, with a contact wiper showing the device in use.

FIG. 3 is a cross-sectional view of one embodiment of the present invention.

### DETAILED DESCRIPTION OF THE EMBODIMENTS

Referring now to the figures, a description of some embodiments of the present invention will be given. It is expected that the present invention may take many other forms and shapes, hence the following disclosure is intended to be illustrative and not limiting, and the scope of the invention should be determined by reference to the appended claims.

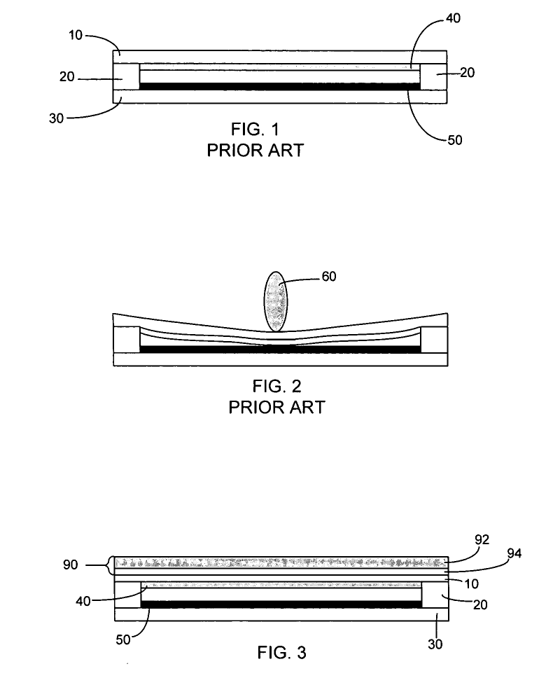

Referring now to FIG. 1, an exemplary touch-controlled apparatus in the prior art is shown with a top layer 10 having a shunt 40 adjacent to a bottom layer 30 having a conductive surface 50. Top layer 10 and shunt 40 may be affixed to one another using any method known to those skilled in the art. Similarly, bottom layer 30 and conductive surface 50 may be affixed to one another using any method known to those skilled in the art. In some embodiments, shunt 40 comprises a collector which may comprise silver or other conductive materials as is known in the art. Conductive surface 50 may comprise carbon or other materials as is known in the prior art. Top layer 10 and bottom layer 30 may be held apart by separator 20. Because shunt 40 is affixed to top layer 10 and conductive surface 50 is affixed to bottom layer 30, the placement of separator 20 between top layer 10 and bottom layer 30 also creates a space between shunt 40 and conductive surface 50. In FIGS. 1-3, the size of separator 20 and of the space between shunt 40 and conductive surface 50 is not to scale.

Referring now to FIG. 2, when a prior art device is in use, contact wiper 60 may depress top layer 10 such that shunt 40 contacts conductive layer 50. The area of top layer 10 on which contact wiper 60 may operate to activate the apparatus may be called the actuation area. When the embodiment comprises a potentiometer, the electrical resistance provided by the apparatus varies depending on the position of contact wiper 60 within the actuation area. Contact wiper 60 may comprise a user's finger, a mechanical implement, or any number of other means capable of exerting a force on top layer 10 sufficient to cause flexure in which shunt 40 comes into contact with conductive surface 50.

In prior art devices as shown in FIG. 1 and FIG. 2, the repeated contact of contact wiper 60 with top layer 10 creates wear on top layer 10 or other portions of the apparatus such that the apparatus will eventually cease to function correctly. This is especially true when contact wiper 60 takes a constant position set in a thermal environment on top layer 10 after a prolonged period of time, depressing top layer 10 to form a pre-actuated contact between shunt 40 and conductive surface 50.

FIG. 3 shows an embodiment of the present invention comprising a pressure-actuated circuit comprising a linear potentiometer having a shielding layer 90 affixed to top layer 10. Shielding layer 90 comprises, in this embodiment, a durable and heat resistant material 92 such as borosilicate or fiberglass, which exhibits the flexibility needed to permit contact wiper 60 (not shown in FIG. 3) to cause shunt 40 to come into contact with conductive surface 50 when supplied with a force consistent with the application for which the apparatus is intended. In one embodiment, the flexibility needed for the combination of top layer 10 and shielding layer 90 is appropriately 10 mils downward across the entire actuation area. In one embodiment, shielding layer 90 further comprises a heat-resistant adhesive 94.

In one embodiment, the flexibility of shielding layer 90 and top layer 10 in combination is such that they may be flexed to permit contact between shunt 40 and conductive surface 50 using an operator's fingertip or a mechanical actuation device. In some embodiments, less flexibility in shielding layer 90 will be required because contact wiper 60 will be engaged with more force than would be exerted by an operator's fingertip.

In one embodiment, shielding layer 90 comprises a layer of a fiberglass material 92 bonded to top layer 10 by an adhesive 94 comprising an epoxy or any similar heat-resistant adhesive. In one embodiment, shielding layer 90 comprises a piece of fiberglass material 92 having a thickness of 5 mils and a heat-resistant adhesive 94 having a thickness of approximately 2 mils.

In some embodiments, shielding layer 90 comprises a thickness of between approximately 1 mil and 10 mils.

Depending upon manufacturing needs and the intended operating environment, top layer 10 may—but need not—be thinner than in prior art devices because of the addition of shielding layer 90.

Shielding layer 90 may increase heat resistance of the apparatus, permitting operation in environments in which prior art devices would likely fail. Experiments have shown that one embodiment of the present invention is able to withstand long-term operating temperatures of 50 degrees Celsius above ambient temperatures.

Further, because shielding layer 90 is a material of generally greater durability compared to top layer 10, contact between contact wiper 60 and shielding layer 90 creates less wear on the device for each use than in prior art devices. Experiments have demonstrated that one embodiment of the present invention is able to withstand more than one million additional use cycles compared to a prior art apparatus. The durability of an apparatus formed according to this embodiment will obviously vary according to the specific materials used to construct the device-including the top layer 10, shunt 40, conductive surface 50, and shielding layer 90 as well as the environment to which the device is subject during operation, including, without limitation, the force with which contact wiper 60 is applied, and the temperature and humidity in which the device operates.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by Letters Patent is:

1. A pressure-actuated circuit comprising
a shunt having a first side and a second side;
a conductive layer having a first side and a second side;
a space disposed between first side of the shunt and the first side of the conductive layer;
a top layer having a first side and a second side, wherein the first side of the top layer is substantially adjacent to the second side of the shunt;
a shielding layer having a first side and a second side, where the first side of the shielding layer is substantially adjacent to the second side of the top layer.

2. The circuit of claim 1 wherein the first side of the shielding layer is affixed to the second side of the top layer using an adhesive.

3. The circuit of claim 2 wherein the adhesive is heat resistant.

4. The circuit of claim 1 wherein the circuit is capable of sustained operations at temperatures above 90 degrees Celsius.

5. The circuit of claim 1 wherein the shielding layer comprises a material selected from the group consisting of borosilicate and fiberglass.

6. The circuit of claim 1 wherein the shielding layer comprises a thickness of between 1 mil and 10 mils.

7. The circuit of claim 2 wherein the adhesive comprises an epoxy.

8. A pressure-actuated circuit comprising
a shunt having a first side and a second side;
a conductive layer having a first side and a second side;
a space disposed between first side of the shunt and the first side of the conductive layer;
a shielding layer having a first side and a second side, where the first side of the shielding layer is substantially adjacent to the second side of the shunt.

9. The circuit of claim 8 wherein the first side of the shielding layer is affixed to the second side of the shunt using an adhesive.

10. The circuit of claim 9 wherein the adhesive is heat resistant.

11. The circuit of claim 8 wherein the circuit is capable of sustained operations at temperatures above 90 degrees Celsius.

12. The circuit of claim 8 wherein the shielding layer comprises a material selected from the group consisting of borosilicate and fiberglass.

13. The circuit of claim 8 wherein the shielding layer comprises a thickness of between 1 mil and 10 mils.

14. The circuit of claim 9 wherein the adhesive comprises an epoxy.

15. A method of manufacturing a pressure-actuated circuit comprising
providing a shunt having a first side and a second side;
providing a conductive layer having a first side and a second side;
providing a space disposed between first side of the shunt and the first side of the conductive layer;
affixing a first side of a shielding layer to the second side of the shunt.

16. The method of claim 15 wherein the first side of the shielding layer is affixed to the second side of the shunt using an adhesive.

17. The method of claim 16 wherein the adhesive is heat resistant.

18. The method of claim 15 wherein the circuit is capable of sustained operations at temperatures above 90 degrees Celsius.

19. The circuit of claim 15 wherein the shielding layer comprises a material selected from the group consisting of borosilicate and fiberglass.

20. A method of using a pressure-actuated circuit comprising
providing a shunt having a first side and a second side and a conductive layer having a first side and a second side, wherein a space is disposed between first side of the shunt and the first side of the conductive layer and the first side of a shielding layer having a first side and a second side is affixed to the second side of the shunt.
exerting pressure on the second side of the shielding layer so as to cause the first side of the shunt to contact the first side of the conductive layer over at least a portion of its length.
